(19) United States
(12) Patent Application Publication
(10) Pub. No.: US 2026/0339948 A1
(43) Pub. Date: Oct. 29, 2026

(54) DATA QUERY METHOD, APPARATUS, ELECTRONIC DEVICE, STORAGE MEDIUM, AND PROGRAM PRODUCT

(71) Applicant: BEIJING YOUZHUJU NETWORK TECHNOLOGY CO., LTD., Beijing (CN)

(72) Inventors: Jinghao HU, Beijing (CN); Xuefeng LIU, Beijing (CN); Yongfu MA, Beijing (CN); Qiaokai JIA, Beijing (CN)

(21) Appl. No.: 19/661,421

(22) Filed: Apr. 28, 2026

(30) Foreign Application Priority Data
Apr. 28, 2025 (CN) 202510550387.6

(51) Int. Cl. G06F 16/2453

(52) U.S. Cl. CPC G06F 16/24542

(57) ABSTRACT

Provided are a data query method and apparatus, an electronic device, a storage medium and a program product, which relate to the technical field of data processing, artificial intelligence, large models and large language models. The method includes: in response to a query instruction for a first query question, displaying the first query question on an interactive page, and triggering processing of the first query question according to a query plan, where the query plan includes a plurality of query steps; displaying a first processing result of each of the query steps on the interactive page; and triggering re-query for the first query question in response to a modification instruction for the first processing result of a target query step to obtain and display a second processing result of each of the query steps.

### CROSS-REFERENCE TO RELATED APPLICATIONS

The present application is based on and claims the benefit of the priority to the Chinese application No. 202510550387.6 filed on Apr. 28, 2025, the disclosure of which is incorporated herein in its entirety.

### TECHNICAL FIELD

The present application relates to the field of data processing technology, artificial intelligence technology, large model technology, and large language model technology, and in particular, to a data query method and apparatus, an electronic device, a storage medium, and a program product.

### BACKGROUND

In a data query process, a user generally gives a query question through an interactive interface, and after processing by a back-end program, a query result is fed back to a front end and displayed on the interactive interface of the front end. The interactive interface of the front end is used for displaying the query result, and in the case of a query error, a reason for the error cannot be known, and the query question needs to be corrected before re-asking.

### SUMMARY

In view of this, the present application provides a data query method and apparatus, an electronic device, a storage medium, and a program product.

In a first aspect, the present application provides a data query method, including:
displaying a first query question on an interactive page in response to a query instruction for the first query question, and triggering processing of the first query question according to a query plan, where the query plan includes a plurality of query steps;
displaying a first processing result of each of the query steps on the interactive page; and
triggering re-query for the first query question in response to a modification instruction for the first processing result of a target query step to obtain and display a second processing result of each of the query steps.

In a second aspect, the present application provides a data query method, including:
obtaining a query instruction for a first query question from a query object;
processing the first query question according to a query plan to obtain a first processing result of each query step in the query plan, where the query plan includes a plurality of query steps;
feeding back the first processing result of the query step to a requester of the query instruction in sequence based on an order of the query steps, where an interactive page of the requester is configured to display a processing result of the query step;
obtaining a modification instruction for the first processing result of a target query step;
re-querying the first query question based on a modification result and the query plan to obtain a second processing result of each of the query steps; and
feeding back the second processing result of the query step to the requester of the query instruction in sequence based on the order of the query steps.

In a third aspect, the present application provides a data query apparatus, including:
a query question display module, configured to display a first query question on an interactive page in response to a query instruction for the first query question, and trigger processing of the first query question according to a query plan, where the query plan includes a plurality of query steps;
a first processing result display module, configured to display a first processing result of each of the query steps on the interactive page; and
a second processing result display module, configured to trigger re-query for the first query question in response to a modification instruction for the first processing result of a target query step to obtain and display a second processing result of each of the query steps.

In a fourth aspect, the present application provides a data query apparatus, including:
an instruction obtaining module, configured to obtain a query instruction for a first query question from a query object;
a first processing module, configured to process the first query question according to a query plan to obtain a first processing result of each query step in the query plan, where the query plan includes a plurality of query steps;
a first feedback module, configured to feed back the first processing result of the query step to a requester of the query instruction in sequence based on an order of the query steps, where an interactive page of the requester is configured to display a processing result of the query step;
an instruction modification module, configured to obtain a modification instruction for the first processing result of a target query step;
a re-query module, configured to re-query the first query question based on a modification result and the query plan to obtain a second processing result of each of the query steps; and
a second feedback module, configured to feed back the second processing result of the query step to the requester of the query instruction in sequence based on the order of the query steps.

In a fifth aspect, the present application provides an electronic device, including: at least one memory and at least one processor, where the at least one memory and the at least one processor are communicatively connected to each other, the at least one memory stores computer instructions, and the at least one processor executes the computer instructions to perform the data query method according to the first aspect or any corresponding implementation thereof.

In a sixth aspect, the present application provides a computer-readable storage medium, where the computer-readable storage medium stores computer instructions, and the computer instructions are configured to enable a computer to perform the data query method according to the first aspect or any corresponding implementation thereof.

In a seventh aspect, the present application provides a computer program product, including computer instructions, where the computer instructions are configured to enable a computer to perform the data query method according to the first aspect or any corresponding implementation thereof.

### BRIEF DESCRIPTION OF THE DRAWINGS

In order to more clearly explain the technical solutions in the specific embodiments of the present application or in the related art, the following will briefly introduce the drawings that need to be used in the description of the specific embodiments or the related art. Obviously, the drawings in the following description are some embodiments of the present application. For those of ordinary skill in the art, other drawings may be obtained based on these drawings without creative efforts.

FIG. 1 is a schematic diagram of an application scenario according to an embodiment of the present application;

FIG. 2 is a first schematic flowchart of a data query method according to an embodiment of the present application;

FIG. 3 is a first schematic diagram of an interactive page according to an embodiment of the present application;

FIG. 4 is a second schematic diagram of an interactive page according to an embodiment of the present application;

FIG. 5 is a second schematic flowchart of a data query method according to an embodiment of the present application;

FIG. 6 is a first schematic processing diagram of a data query method according to an embodiment of the present application;

FIG. 7 is a second schematic processing diagram of a data query method according to an embodiment of the present application;

FIG. 8 is a first structural block diagram of a data query apparatus according to an embodiment of the present application;

FIG. 9 is a second structural block diagram of a data query apparatus according to an embodiment of the present application; and

FIG. 10 is a schematic hardware structural diagram of an electronic device according to an embodiment of the present application.

### DETAILED DESCRIPTION

In order to make the objectives, technical solutions and advantages of embodiments of the present application clearer, the technical solutions in the embodiments of the present application will be described clearly and completely below in combination with the drawings in the embodiments of the present application. Obviously, the described embodiments are part of the embodiments of the present application, not all of them. Based on the embodiments in the present application, all other embodiments obtained by those skilled in the art without making creative efforts belong to the protection scope of the present application.

It may be understood that before using the technical solutions disclosed in the embodiments of the present disclosure, users should be informed of the type, scope of use, use scenarios, etc. of personal information involved in the present disclosure and obtain the authorization of the users in an appropriate manner in accordance with relevant laws and regulations.

For example, in response to receiving an active request from a user, prompt information is sent to the user to clearly prompt the user that the requested operation will require access to and use of the user’s personal information. In this way, the user may independently choose whether to provide personal information to software or hardware, such as an electronic device, an application, a server, or a storage medium, that performs the operations of the technical solutions of the present disclosure based on the prompt information.

As an optional but non-limiting implementation, in response to receiving an active request from a user, the prompt information may be sent to the user in the form of, for example, a pop-up window, in which the prompt information may be presented in text. In addition, the pop-up window may also include a selection control for the user to choose whether to “agree” or “disagree” to provide personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

It may be understood that the data involved in this technical solution (including but not limited to the data itself, acquisition or use of the data) should comply with the requirements of corresponding laws, regulations and related provisions.

In the related art, for a data query task, generally, after a question is given, a query result is displayed on an interactive page. In this process, since the final query result is displayed on the interactive page, if the query result does not meet requirements, a query question may only be reconstructed for re-query. At the same time, since a reason why the query result does not meet the requirements is not clear, the query question needs to be modified multiple times to obtain a satisfactory result.

Further, since a user gives a query question to display of the query result on the interactive page, a period of time, for example, a few seconds or dozens of seconds, may be required to wait. During this period of time, the user may only wait, which leads to poor user experience.

Based on this, an embodiment of the present disclosure provides a data query method. In the method, in a process of processing a first query question, the processing is performed according to a query plan, and a corresponding first processing result is displayed for each query step in the query plan. The first processing result of each query step is displayed, so that a user may intuitively understand a processing condition of each query step, and an inaccurate processing result may be modified in an interactive manner to trigger re-query. In the method, a query result of each query step may be intuitively displayed, which facilitates intuitive understanding of an inaccurate query step, so that the inaccurate query step may be modified in time and then re-query is performed, thereby improving query efficiency.

As used in the embodiments of the present application, the term “model” may learn a correlation between corresponding input and output from training data, so that a corresponding output may be generated for a given input after training is completed. The model may be generated based on machine learning techniques, etc. Taking deep learning as an example, deep learning is a machine learning algorithm that uses multiple layers of processing units to process input and provide corresponding output. In the embodiments of the present application, the model may also be referred to as a machine learning model, a machine learning network or a network, which may be used interchangeably herein. One model may include different types of processing units or networks.

As an optional application scenario of the embodiments of the present disclosure, as shown in FIG. 1, an application 101 is installed on a terminal device 110, and a user 130 may interact with the application 101 through the terminal device 110 and/or an access device of the terminal device 110.

Exemplarily, the application 101 may be any application that may provide a service related to question answering. For example, the application 101 may be a resource recommendation application. In the application scenario shown in FIG. 1, if the application 101 is in an active state, the terminal device 110 may present an interface 102 of the application 101. The interface 102 may include various types of pages that may be provided by the application 101, such as an interactive page, a settings page, and a query page.

In some embodiments, the terminal device 110 is communicatively connected to a server 120 to implement provision of the service of the application 101. The terminal device 110 may be a mobile terminal, a fixed terminal, a portable terminal, etc., including but not limited to a mobile phone, a desktop computer, a notebook computer, a multimedia tablet, an e-book device, a game device, or any combination thereof, including accessories and peripherals of these devices or any combination thereof. In some embodiments, the terminal device 110 may also support any type of interface, and the server 120 may be various types of computing systems and servers that may provide computing power, including but not limited to mainframes, edge computing nodes, computing devices in cloud environments, etc.

A user gives a query question through interaction with the terminal device 110, and the server 120 analyzes and processes the query question to obtain a processing result of each query step, which is fed back to the terminal device 110 for display.

It should be noted that FIG. 1 is only an example of an application scenario and does not limit the protection scope of the present disclosure.

The embodiments of the present disclosure will be described below in conjunction with the drawings. It should be understood that the pages shown in the drawings are only examples, and various page designs may actually exist. Each graphic element in the page may have different arrangements and different visual representations, one or more of the elements may be omitted or replaced, and there may also be one or more other elements, which is not limited in the embodiments of the present disclosure. In addition, the embodiments are mainly described for the terminal device 110 below. It should be understood that the actions described with respect to the terminal device 110 may be performed by the application 101 on the terminal device 110, or may be performed by the application 101 in cooperation with its server (for example, the server 120).

According to an embodiment of the present application, an embodiment of a data query method is provided. It should be noted that the steps shown in the flowcharts of the drawings may be executed in a computer system such as a set of computer executable instructions, and although a logical order is shown in the flowcharts, in some cases, the steps shown or described may be executed in an order different from that here.

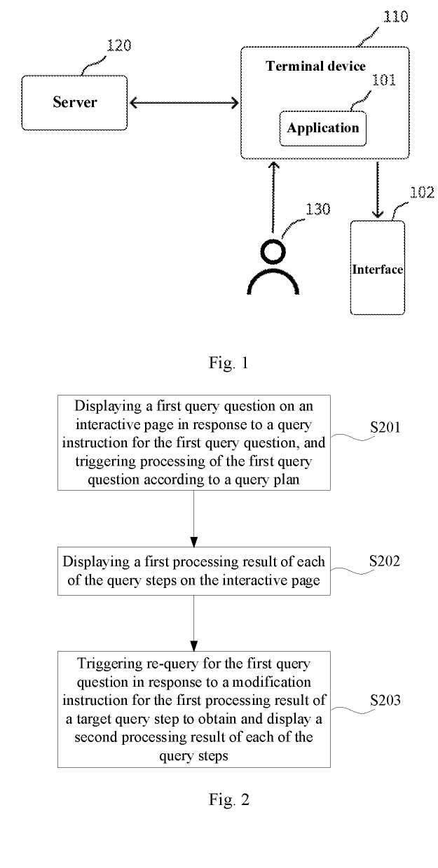

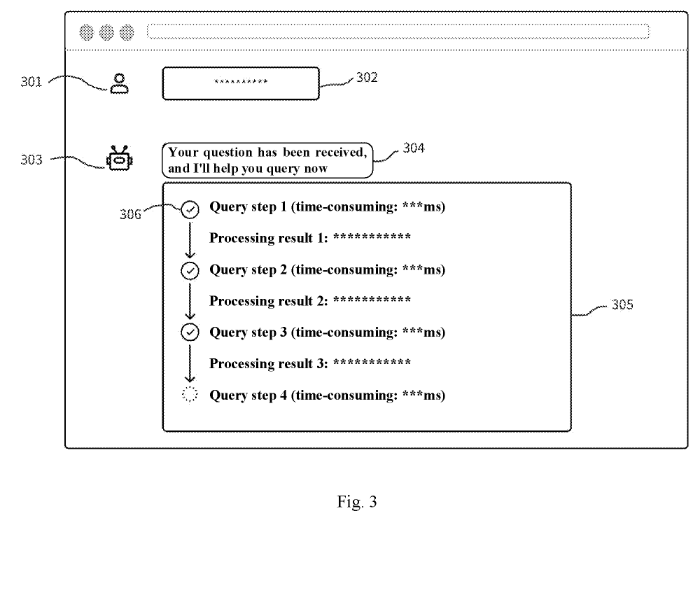

In this embodiment, a data query method is provided, which may be used for the above-mentioned terminal device. FIG. 2 is a flowchart of the data query method according to an embodiment of the present application. As shown in FIG. 2, the process includes the following steps:

Step S201: displaying a first query question on an interactive page in response to a query instruction for the first query question, and triggering processing of the first query question according to a query plan.

The query plan includes a plurality of query steps.

The first query question is used in a query task, that is, a user gives a query question through interaction with the interactive page, and an agent thinks according to the question and gives a query result. For the convenience of description below, the query question input by the user is referred to as the first query question in this embodiment.

The query instruction for the first query question may be input by the user through interaction with the interactive page, and on this basis, the query is triggered, that is, the query instruction for the first query question is generated. An input form of the first query question includes but is not limited to text input, voice input, etc., which is specifically set according to actual needs. Correspondingly, different types of input modes correspond to different input controls on the interactive page. Taking a voice input instruction as an example, a voice interactive control is displayed on the interactive page, and the first query question is acquired through interaction with the voice interactive control.

The interactive page is used to represent a page provided by a query application, and a first question is displayed in a first area of the interactive page. The first question is a question obtained in response to an input instruction of a question answering task. Corresponding to the input instruction described above, the first question includes but is not limited to text, text and pictures, text and files, etc. For example, the first question includes only a question description, or includes a picture and a question description, or includes a file and a question description, etc.

In response to the query instruction for the first query question, the first query question is displayed on the interactive page, and processing of the first query question is triggered. Specifically, the processing of the first query question is performed according to the query plan, and the query plan includes a plurality of query steps. For data query tasks, the query steps included in the query plan may be the same or may be set according to different first query questions. Correspondingly, if the query plan is applicable to all query tasks, the query plan may be pre-configured and may be called during a query process; if the query plan is related to the query question, after the query question is acquired, the query question is understood by a language model to generate the query plan. Certainly, the query plan may also be generated in other ways, which is not limited here.

Step S202: displaying a first processing result of each of the query steps on the interactive page.

As described above, the query plan represents a thinking process of the agent. The thinking process includes a plurality of query steps, and the first processing result may be obtained for each query step. In this embodiment, the first processing result of each query step is displayed on the interactive page, so that the user may know a processing condition of the query step in time.

Exemplarily, as shown in FIG. 3, a user 301 gives a first query question 302 through interaction with the interactive page, and accordingly, the first query question 302 is displayed on the interactive page. An agent 303 gives an answer prompt 304 for the first query question 302, such as "Your question has been received, and I'll help you query now". After the answer prompt 304, the query steps in the query plan and a first processing result 305 of each query step are displayed. Further, as shown in FIG. 3, in this example, the query plan includes four query steps: query step 1 to query step 4. For each query step, a processing state identification 306 is given, and different processing states correspond to different processing state identifications. In addition, a processing time of the query step may also be given for each query step, which is convenient for the user to intuitively understand.

Step S203: triggering re-query for the first query question in response to a modification instruction for the first processing result of a target query step to obtain and display a second processing result of each of the query steps.

Since the first processing result of each query step is displayed on the interactive page, the user may intuitively understand the query step that causes the query result not to meet the requirements. Since the first processing result of the query step is obtained through automatic analysis, there may be a processing result that does not meet the requirements, which in turn leads to an unsatisfactory query result. Therefore, the user may interact with the interactive page to modify the first processing result of the target query step, and accordingly, the modification instruction for the first processing result of the target query step is generated.

The target query step is used to represent a query step that needs to be modified. In the query plan, the modification function may be provided for the first processing result of all query steps, or the modification function may be provided for the first processing result of some query steps, which is specifically set according to actual needs and is not limited here.

The modification instruction is generated after the first processing result of the target query step is modified, and accordingly, a new query plan is generated, and then the re-query is performed according to the new query plan to obtain the second processing result of each query step. The first processing result and the second processing result are used to distinguish processing results generated at different times. Similar to the first processing result, after the second processing result is obtained, the second processing result of each query step is displayed on the interactive page.

It should be noted that for a display mode of the second processing result, the second processing result may be displayed in an overlay manner over the first processing result, or the second processing result may be displayed after the first processing result, or the second processing result may be displayed in other manners, which is not limited here. In addition, for each query plan, a version number thereof may also be recorded. Correspondingly, the generated first processing result is associated with the version number of the query plan, and subsequently, the version number of the query plan may be used to review the processing result.

According to the data query method provided in this embodiment, in the process of processing the first query question, the processing is performed according to the query plan, and the corresponding first processing result is displayed for each query step in the query plan. The first processing result of each query step is displayed, so that the user may intuitively understand the processing condition of each query step, and the inaccurate processing result may be modified in an interactive manner to trigger re-query. In the method, the query result of each query step may be intuitively displayed, which facilitates intuitive understanding of the inaccurate query step, so that the inaccurate query step may be modified in time and then re-query is performed, thereby improving query efficiency.

In some optional implementations, the query steps include question parsing and data query, and accordingly, a parsed field of the question parsing and a field value of the parsed field are displayed on the interactive page, and query data is displayed in a first style.

The question parsing in the query step represents decomposition of the first query question, for example, an indicator, a dimension, time information, etc. involved in the question. The indicator, the dimension and the time information are referred to as parsed fields, and specific values are referred to as field values of the parsed fields.

Under the query step of question parsing, the parsed field for the first query question and the field value of the parsed field are displayed. It may be understood here that different first query questions correspond to different parsed fields and different field values of the parsed fields.

The data query represents a final data query result, and since a queried object is data, a data display form is involved, including but not limited to a line chart, a table, a radar chart, etc. The display form of the query data may be given in the first query question, and if the first query question does not give a description of the display form, the query data is displayed in a default form.

Exemplarily, the query data is displayed in a first style. The first style may be given in the first query question or may be a default display style.

In some optional implementations, the target query step includes at least one of question parsing and data query. The first processing result of the question parsing includes the parsed field and the field value of the parsed field. The first processing result of the data query includes displaying the query data in the first style.

As described above, the query steps of the query plan may all provide a modifiable function, or some of the query steps may provide the modifiable function. In this embodiment, the query step providing the modifiable function is referred to as the target query step, which includes at least one of question parsing and a data center. That is, each time the first query result of the query step is modified, the first processing result of the question parsing may be modified, the first processing result of the data query may be modified, or the first processing results of the question parsing and the data query may be modified, etc., which is specifically modified according to actual needs and is not limited here.

The query step and the first processing result thereof are displayed on the interactive page, and accordingly, the first processing result of the question parsing includes the parsed field and the field value of the parsed field, and the first processing result of the data query includes displaying the query data in the first style.

Specifically, the parsed field corresponding to the question parsing and the field value of the parsed field are related to the first query question, and in the modification process, the field value of the parsed field may be modified, or further, the parsed field and the field value may be modified, etc. The query result of the data query is represented by the query data, and the query data is displayed in the first style. If the first style does not meet requirements, the display style may be modified in an interactive manner. That is to say, the modification of the first processing result of the data query is the modification of the display style.

In some optional implementations, the above step S203 includes:
Step a1: determining a modification result in response to the modification instruction for the field value of the parsed field and/or the first style; and
Step a2: triggering re-query for the first query question based on the modification result in response to an interactive instruction on a re-query control on the interactive page to obtain and display the second processing result of each of the query steps.

Exemplarily, the modification of the query step of question parsing is the modification of the field value of the parsed field, and accordingly, the modification instruction for the field value is generated. The modification of the query step of data query is the modification of the display style, and accordingly, the modification instruction for the display style is generated.

After the field value of the parsed field and/or the first style are modified, the interactive instruction on re-query is generated through interaction with the re-query control on the interactive page, which is used to trigger re-query for the first query file based on the modification result to obtain the second processing result of each query step and display the second processing result on the interactive page.

Exemplarily, the query steps further include question rewriting, topic routing, and question recommending, and processing results of the question rewriting, the topic routing, the question parsing, the data query, and the question recommending are displayed in sequence on the interactive page.

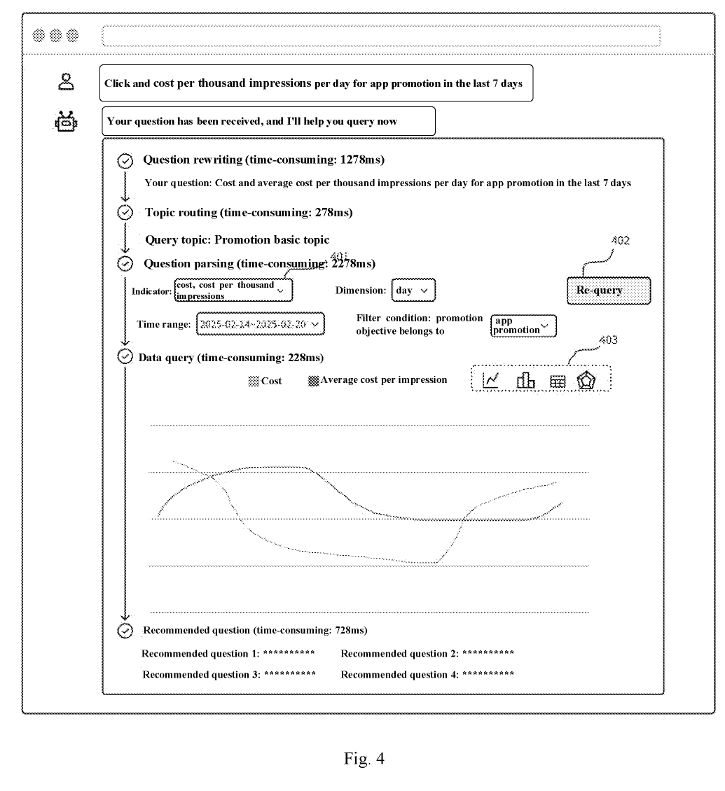

For example, as shown in FIG. 4, the query plan generated for the first query question given by the user includes five query steps, which are, in sequence, processing results of the question rewriting, the topic routing, the question parsing, the data query, and the question recommending. A corresponding first processing result is displayed for each query step, and in addition, a processing state is also displayed corresponding to each query step, including but not limited to in progress, completed, paused, etc., which is not specifically limited.

Exemplarily, the question rewriting is to rewrite the first query question provided by the user into a language description that may be understood by the large model after semantic understanding is performed on the first query question. The topic routing is used to determine a topic corresponding to the first query question. The question parsing is used to parse the rewritten question to determine a key field and a field value. The data query is used to display queried data in a corresponding display style. The question recommending is used to give a question associated with the first query question.

In FIG. 4, field values for the question parsing include an indicator, a dimension, a time range, and a filter condition. A modification control is provided for each parsed field, for example, the parsed field of the indicator corresponds to a field value modification control 401. For the data query, a display style modification control 403 is provided on the interactive page. Certainly, the field value modification control 401 and the display style modification control 403 are only examples of controls in FIG. 4, and do not limit the protection scope of the present application.

After the first processing result of each query step is obtained through analysis of the query plan, the first processing result is displayed on the interactive page. If there is a first processing result that does not meet the requirements, it is modified in an interactive manner. For example, the field value modification control and/or the display style control may be interacted with to obtain a modified field value and/or a modified display style.

After the modification is completed, interaction with a re-query control 402 triggers re-query for the modified first processing result to obtain the second processing result of each query step.

In the process of processing the first query question, the processing is performed in sequence according to an order of the question rewriting, the topic routing, the question parsing, the data query, and the question recommending, the given first query question is rewritten into a question that may be understood by the language model, and on this basis, the topic routing is performed to locate the topic to be queried, and the question parsing is further performed to determine a refined query direction, thereby obtaining an accurate data query result. Finally, the question recommendation is performed to facilitate further expansion of the question.

In the processing process of the data query, the processing result of the query step is displayed to reduce a waiting time of page display content on the interactive page after the query question is acquired. That is, a strategy of phased information disclosure is adopted to display the progress of each link to the user, and clearly inform the user which specific process the current query is being processed.

According to an embodiment of the present application, an embodiment of a data query method is provided. It should be noted that the steps shown in the flowcharts of the drawings may be executed in a computer system such as a set of computer executable instructions, and although a logical order is shown in the flowcharts, in some cases, the steps shown or described may be executed in an order different from that here.

In this embodiment, a data query method is provided, which may be used for the above-mentioned server. FIG. 5 is a flowchart of the data query method according to an embodiment of the present application. As shown in FIG. 5, the process includes the following steps:

Step S501: obtaining a query instruction for a first query question from a query object.

The first query question is input by the query object through interaction with the interactive page to trigger the query, and accordingly, the query instruction for the first query question is generated. In addition, for details of the query instruction, see the above description, which will not be repeated here.

Step S502: processing the first query question according to a query plan to obtain a first processing result of each query step in the query plan.

The query plan includes a plurality of query steps.

For the query plan and the query steps, see the detailed description above, which will not be repeated here.

For each query step, input content may be processed by a corresponding large model to obtain a corresponding processing result. Alternatively, the processing result may be obtained after corresponding data is parsed. A processing manner of each query step is not limited here.

For example, for the question rewriting, the first query question may be input into a question rewriting model to obtain a result of the question rewriting. For the topic routing, the result of the question rewriting may be input into a topic classification model to obtain a topic route corresponding to the first query question. For the question parsing, semantic analysis may be performed in combination with a determined topic and the rewritten question to obtain the parsed field and the field value. For the data query, a query instruction may be generated in combination with a result of the question parsing, and the query data is obtained by querying in a corresponding database. For the question recommendation, the first query question may be used to match in a question library, and a question with a similarity greater than a preset threshold is taken as the recommended question.

It should be noted that the above processing manner for each query step is only an example, and does not limit the protection scope of the present application, and may be specifically set according to actual needs.

Step S503: feeding back the first processing result of the query step to a requester of the query instruction in sequence based on an order of the query steps.

An interactive page of the requester is configured to display a processing result of the query step.

The order of the query steps is represented by the query plan, and according to the order of each query step, after the first processing result of the query step is obtained, the first processing result of the query step is fed back to the requester of the query instruction to be displayed on the interactive page of the requester. That is, each time the first processing result of the query step is obtained, the first query result is fed back to the requester of the query instruction, without waiting for all query steps to be completed.

Step S504: obtaining a modification instruction for the first processing result of a target query step.

As described above, the first processing result of the query step may not meet the requirements, and then, this part of the query step is referred to as the target query step, and the user may modify the first processing result thereof to generate the modification instruction accordingly. For the server, the obtained modification instruction may be represented by a database language SQL (Structured Query Language).

Exemplarily, in a process of generating the first processing result or after the first processing result is generated, the requester of the query instruction records an SQL statement used for the data query this time. Then, after the first processing result is modified, the SQL statement may be modified, and the modified SQL statement is used as the modification instruction.

Step S505: re-querying the first query question based on the modification result and the query plan to obtain a second processing result of each of the query steps.

After the modification instruction is acquired, the first query question is re-query based on the modification result and the query plan. For example, the second processing result of each query step is obtained by performing the same operation as that for obtaining the first processing result.

Step S506: feeding back the second processing result of the query step to the requester of the query instruction in sequence based on the order of the query steps.

Similar to the feedback manner of the first processing result, the second processing result of each query step is fed back to the requester of the query instruction in sequence based on the order of the query steps.

It should be noted that although the above description only involves one modification, the protection scope of the present application is not limited thereto, and the specific number of modifications is determined according to actual needs and is not limited here.

According to the data query method provided in this embodiment, after the query instruction is acquired, the processing is performed according to each query step in the query plan, and the first processing result of each query step is fed back, so that the requester may know the processing result of each query step in time, and it is convenient for the user to intuitively understand the processing condition of each query step. The inaccurate processing result may be modified in an interactive manner to trigger re-query, thereby improving query efficiency.

In some optional implementations, the query steps include question rewriting, and accordingly, the above step S502 includes:
Step b1: obtaining a historical conversation between the query object and the agent.

Each round of conversation between the query object and the agent may correspond to a unique identification, and the unique identification remains unchanged in all conversations of the current round of conversation. If the current round of conversation ends, and the next round of conversation is started next time, a unique identification of the next round is given again.

In the same round of conversation, it may be considered that conversation content is relevant. Therefore, in order to rewrite the first query question more accurately subsequently, it is necessary to acquire the historical conversation between the query object and the agent here. Alternatively, it may also be understood as obtaining a conversation context of the first query question.
Step b2: determining a replacement word of a target word if the target word exists in the first query question.

The target word is used to represent a special word that is difficult to be understood by the large model, and these special words may be configured in advance. In a target word query process, the special words may be used to match in the first query question in sequence to determine whether the target word exists in the first query question.

If the target word exists in the first query question, the replacement word of the target word needs to be determined. A mapping relationship between the target word and the replacement word may be configured in advance, for example, a mapping relationship between the special word and the replacement word is configured in advance, and the mapping relationship may be recorded in a table.

Exemplarily, the method further includes:
Step b21: obtaining a word mapping corresponding to the query object, the word mapping being used to represent the mapping relationship between the target word and the replacement word; and
Step b22: determining that the target word exists in the first query question if a word in the first query question may be queried in the word mapping.

Specifically, the word mapping is related to the query object. Different query objects may have the same word mapping or different word mappings. For example, query objects from the same source may correspond to the same word mapping, while query objects from different sources correspond to different word mappings. Exemplarily, if a query object 1 belongs to a resource recommendation platform A, and a query object 2 comes from a resource recommendation platform B, since the query objects come from different resource recommendation platforms, corresponding word mappings are also different. Therefore, when obtaining the word mapping, it is necessary to acquire the word mapping corresponding to the query object.

The word mapping is used to match in the first query question to determine whether the target word exists in the first query question. If a match may be found, it represents that the target word exists in the first query question. Accordingly, the replacement word of the target word is configured in the word mapping, so the replacement word of the target word may be acquired after the target word is determined.

Different query objects have corresponding word mappings, and the word mapping is used to query words in the first query question, which may improve efficiency and accuracy of the target word query.

Step b3: generating first prompt information based on the first query question, the historical conversation, and the replacement word of the target word.

The first query question is the original query question given by the query object, and the first prompt information is generated by combining the first query question, the historical conversation, and the replacement word of the target word. Exemplarily, the large language model may provide a template for the prompt information, and the first prompt information may be obtained by filling the above three into the template.

Step b4: outputting a rewritten question of the first query question based on the first prompt information using a question rewriting model, the first processing result of the question rewriting including the rewritten question.

The first prompt information is used to instruct the question rewriting model to rewrite the first query question to obtain the rewritten question. Specifically, input of the question rewriting model includes the first prompt information, and output includes the rewritten question of the first query question. The question rewriting model may perform fine-tuning on a pre-trained language model in combination with fine-tuning data in a data query scenario on the basis of the pre-trained language model to obtain the question rewriting model.

After the first query question is received, the question rewriting is performed on the first query question, which is convenient for the subsequent question rewriting model to process. In addition, the historical conversation and the replacement word of the target word are combined in the process of question rewriting, which further improves accuracy of the question rewriting.

In some optional implementations, the query steps include topic routing, and accordingly, the above step S502 includes:

Step c1: obtaining information about a query topic corresponding to the query object, the information about the query topic including at least one of a field under the query topic or enumeration meta-information.

Information about the respective query topic is maintained for the query object, and after the first query question is acquired, the information about the query topic corresponding to the query object may be acquired through an identification of the query object. Certainly, the mapping relationship between the query object and the information about the query topic may be queried not only through the identification of the query object, but also through other manners, which is not limited here.

Specifically, the information about the query topic includes the query topic, and at least one of a field and enumeration information under each query topic. The field under the query topic includes but is not limited to an indicator field and a dimension field, and the indicator field and the dimension field included under different query topics are not all the same. For example, if the query topic is basic data of a recommended resource, the indicator field includes but is not limited to cost, and the dimension field includes but is not limited to a resource provider id, a plan id, and a promotion plan, where the promotion plan has enumeration meta-information: promotion manner 1 and promotion manner 2; and if the query topic is material data of the recommended resource, the indicator field includes but is not limited to cost, and the dimension field includes but is not limited to a material id and a material type, where the material type includes enumeration meta-information: title, video, and picture.

Step c2: performing word segmentation on the rewritten question of the first query question based on the information about the query topic to obtain a recall result of a keyword under each of the query topics.

In the process of performing word segmentation on the rewritten question of the first query question, processing may be performed through a word segmentation algorithm in combination with a pre-configured dictionary and the information about the query topic. The word segmentation algorithm includes but is not limited to Jieba word segmentation, rule-based word segmentation, and regular expression-based word segmentation, etc.

Exemplarily, Jieba word segmentation is used to segment the rewritten question into keywords (a dictionary of the word segmentation algorithm comes from a fixed configuration in code and fields/enumeration meta-information of all query topics of the query object). After word segmentation, it is determined whether the keyword is a special word that needs to be replaced, and if so, the special word is replaced according to the mapping relationship between the special word and the replacement word.

After word segmentation, vector recall of the field and the enumeration meta-information may be obtained for the keyword of the rewritten question under each query topic, which is referred to as the recall result. The keyword represents a word obtained after the rewritten question is segmented, and these keywords are matched under each query topic to obtain the recall result of each query topic. For example, the rewritten question is segmented into five keywords, and these five keywords are matched under each query topic, and a recall result of the five keywords may be obtained for each query topic. That is, for the same rewritten question, there is a corresponding recall result under each query topic.

In combination with the above example, under the query topic of the basic data of the recommended resource, the recall result of the rewritten question includes the indicator field, the dimension field, and the enumeration meta-information of the dimension field; and under the query topic of the material data of the recommended resource, the recall result of the rewritten question includes the indicator field, the dimension field, and the enumeration meta-information of the dimension field.

Under the same query topic, there may be multiple recall results for the same keyword, and there may also be multiple pieces of enumeration meta-information. For example, the recall result of a certain keyword under a certain query topic includes indicator field 1 to indicator field 4, dimension field 1 to dimension field 5, and enumeration meta-information 1 to enumeration meta-information 3. In addition to a recall field, the recall result further includes a recall distance corresponding to the recall field, where the recall distance represents a similarity degree between the recall field and the keyword in the rewritten question.

Step c3: filtering the recall result for each of the query topics to obtain a recall field with a smallest distance in the recall result for the keyword.

Since there may be multiple recall results corresponding to the same keyword under the same query topic, the recall results are filtered to retain the recall field with the smallest recall distance. Continuing with the above example, recall distances of indicator field 1 to indicator field 4 are compared, and an indicator field with a smallest recall distance is retained; recall distances of dimension field 1 to dimension field 5 are compared, and a dimension field with a smallest recall distance is retained; and recall distances of enumeration meta-information 1 to enumeration meta-information 3 are compared, and enumeration meta-information with a smallest recall distance is retained.

Step c4: screening the query topics based on the smallest distance corresponding to the recall result of the keyword under each of the query topics to determine a target query topic of the first query question.

After preliminary screening described above, a field with a smallest distance in an indicator, a dimension, and enumeration meta-information is retained for the same keyword under the same query topic. Then, recall distances corresponding to all keywords under the same query topic may be added to obtain a sum of recall distances under the query topic. By comparing sizes of the sum of recall distances under each query topic, a query topic with a smallest recall distance is determined as the target query topic of the first query question.

Alternatively, after the sum of recall distances is determined, in combination with a weight of each query topic, sizes are compared after weighting processing is performed to determine the target query topic.

Alternatively, for each query topic, the smallest recall distance may also be compared, and a query topic with the smallest recall distance is determined as the target query topic.

Certainly, the target query topic may also be determined in other manners, which is not limited here.

In the topic routing process, in combination with the information about the query topic corresponding to the query object, the rewritten question is segmented to obtain the recall result of the keyword in the rewritten question under the query topic, thereby implementing preliminary recall. On this basis, the recall result is filtered to obtain the recall field with the smallest distance corresponding to the keyword under each query topic, that is, the recall field with the smallest distance is obtained for each keyword under the query topic; and finally, all query topics are screened according to the smallest distance corresponding to the recall result of the keyword to obtain the target query topic. The query process adopts a gradual screening manner, which improves query efficiency on the basis of ensuring query accuracy.

In some optional implementations, the above step c3 includes:

Step c31: for the keyword under each of the query topics, if a preset identification exists in the recall result corresponding to the keyword, removing the preset identification and content corresponding to the preset identification to obtain a processed recall result.

Under each of the query topics, an information description form of the query topic is not fixed and a description rule is not unified, which may cause a deviation of the recall distance due to different description forms of fields that are essentially the same. Based on this, in this embodiment, the recall result corresponding to the keyword is pre-processed, and then the recall distance is corrected by using the pre-processed recall result. The pre-processing of the recall result may be to remove the preset identification in the recall result and the content corresponding to the preset identification. For example, the recall result includes an indicator field: number (piece), and the keyword is number, then “(piece)” in the indicator field needs to be removed before matching.

The preset identification includes but is not limited to an identification for explaining the field, such as a parenthesis, a square bracket, and a curly bracket, etc.; and the content corresponding to the preset identification represents content in the preset identification, including but not limited to content in the parenthesis, content in the square bracket, and content in the curly bracket, etc.

Step c32: correcting a distance corresponding to the processed recall result based on a matching degree between the keyword and the processed recall result to obtain a corrected distance.

A similarity calculation is performed between the processed recall result and the keyword to obtain a similarity calculation result, that is, the matching degree. A value of the matching degree may be directly used to correct the distance corresponding to the processed recall result to obtain the corrected distance.

Step c33: screening out the recall field with the smallest distance in the recall result for the keyword under the query topic based on the corrected distance.

After the recall distance is corrected, the recall results of the same keyword under each query topic are filtered in a similar manner as described in step c3, and the recall field with the smallest distance is retained.

In the process of filtering the recall result, since the recall result may contain characters that affect the matching degree, the recall result is processed with the preset identification in the filtering process, and the original recall distance is corrected by using the matching degree between the processed recall result and the keyword to ensure the accuracy of the corrected distance. On this basis, the accuracy of recall may be further improved, thereby ensuring the accuracy of subsequent topic screening.

In some optional implementations, the above step c32 includes:
Step c321: if the keyword completely matches the processed recall result, setting the distance corresponding to the processed recall result to a preset minimum distance to obtain the corrected distance;
Step c322: if the keyword does not match the processed recall result, obtaining a suffix word corresponding to the query object;
Step c323: concatenating the keyword and the suffix word to obtain a concatenated result; and
Step c324: if the concatenated result completely matches the processed recall result, setting the distance corresponding to the processed recall result to the preset minimum distance to obtain the corrected distance.

After the above processing of the preset identification, the processed recall result corresponding to the keyword may be obtained. If the two completely match, the distance corresponding to the processed recall result is set to the preset minimum distance, and the preset minimum distance is greater than 0. For example, it is 0.001. The preset minimum distance is set to be greater than 0 instead of equal to 0 to avoid errors in the processing of the preset identification.

Under the data query topic, the field in the information about the query topic may have some suffix words in description, such as id, name, number, rate, etc., and these suffix words may affect the recall distance. Therefore, it is also necessary to concatenate the keyword with these suffix words to obtain the concatenated result, and use the concatenated result to match the processed recall result. If they completely match, the distance corresponding to the processed recall result is set to the preset minimum distance to obtain the corrected distance.

The recall field may contain some common suffix words, therefore, after the keyword and the suffix word of the query object are concatenated, the processed recall result is matched again, which further ensures the accuracy of the corrected distance.

In some optional implementations, the above step c4 includes:
Step c41: counting, for each of the query topics, a first number of recall fields with a distance less than a first preset distance, a second number of recall fields with a distance less than a second preset distance, and a sum of the distances in the recall fields corresponding to all keywords, the first preset distance being less than the second preset distance; and
Step c42: sorting based on a priority of the first number, the second number, the sum of the distances, and a weight of the query topic to determine the target query topic of the first query question.

In the process of determining the target query topic, screening is performed according to a comparison priority. For each query topic, the recall distances corresponding to all keywords are compared in size, the number of recall fields with a recall distance less than the first preset distance is counted to obtain the first number; the number of recall fields with a recall distance less than the second preset distance is counted to obtain the second number; and sizes of all recall distances are summed to obtain the sum of the distances. In addition, a corresponding weight is also set for each query topic.

Specifically, in comparison, first, sizes of the first number are compared, and a query topic with a smallest first number is determined as the target query topic; if the first numbers are the same, sizes of the second number are compared, and a query topic with a smallest second number is determined as the target query topic; if the second numbers are the same, sizes of the sum of the distances are compared, and a query topic with a smallest sum of distances is determined as the target query topic; and if the sum of the distances are also the same, weights of each of the query topics are compared, and a query topic with a greatest weight is determined as the target query topic.

It should be noted that although only the first preset distance and the second preset distance are given in the above description, it does not limit the protection scope of the present application, and specific settings may be made according to actual needs.

When the query topics are screened, sorting is performed according to the priority of the number screened according to different thresholds, the sum of the distances, and the weight of the query topic, which improves efficiency and accuracy of the query topic screening.

In some optional implementations, the query steps include question parsing, and accordingly, the above step S502 includes:
Step d1: obtaining current time information;
Step d2: generating second prompt information based on the current time information, the rewritten question of the first query question, a query topic of the first query question, and an optional parsed field;
Step d3: generating a domain specific language based on the second prompt information using a large language model; and
Step d4: obtaining a parsed field of the first query question and a field value of the parsed field in the domain specific language.

The current time information may be used to represent a time when the query instruction is acquired, and the optional parsed field may represent a parsed field that may be provided in subsequent question parsing. The second prompt information is generated by using the current time information, the rewritten question, the query topic, and the optional parsed field, and the second prompt information is used to instruct the large language model to generate a domain specific language (DSL). For the optional parsed field, if the rewritten question does not include content of this parsed field, a field value of the optional parsed field may be set to empty, and the optional parsed field will not be displayed in subsequent display. The parsed field of the first query question and the field value of the parsed field may be obtained by performing analysis and processing on the specific language model.

The data query is implemented by generating the domain specific language through the large language model, which is more flexible than constructing the domain specific language through code.

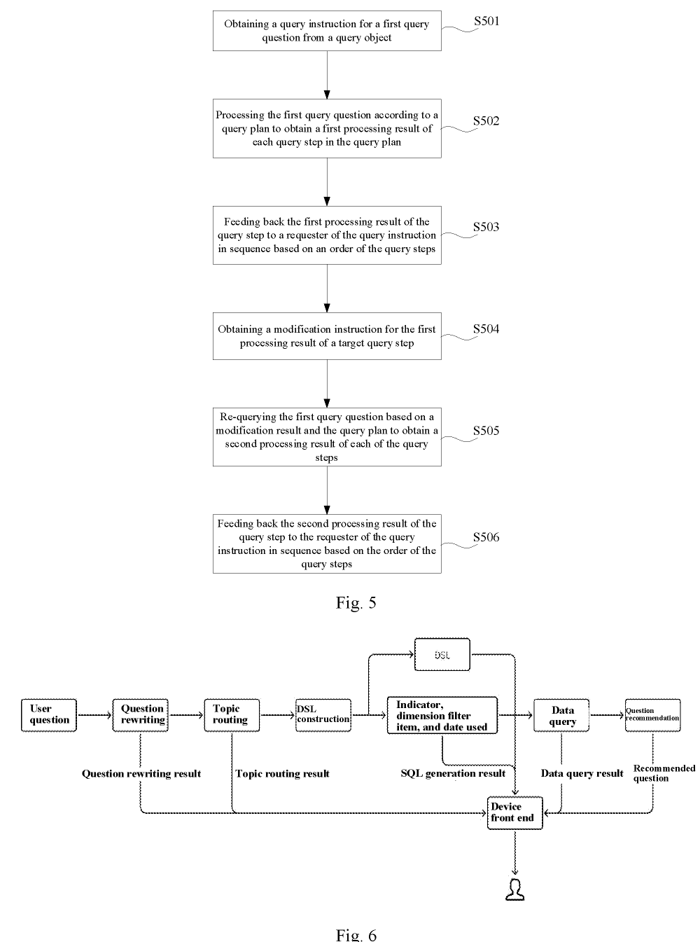

The data query process executed in the server is shown in FIG. 6. After a user question is given, the question is rewritten to obtain a question rewriting result, and the question rewriting result is fed back to a device front end for display. Then topic routing is performed based on the question rewriting result to obtain a topic routing result, and similarly, the topic routing result is fed back to the device front end for display. After the topic routing is completed, DSL construction is performed to obtain a DSL and a parsed field corresponding to the user question, that is, an indicator, a dimension filter item, and a date that are used, and an SQL generation result is obtained and stored at the device front end, which is convenient for generating a new SQL statement to instruct data query after the first processing result is modified subsequently. The DSL is used for subsequent data query, and a data query result is fed back to the device front end for display. Finally, question recommendation processing is further performed to obtain a recommended question, and the recommended question is fed back to the device front end for display.

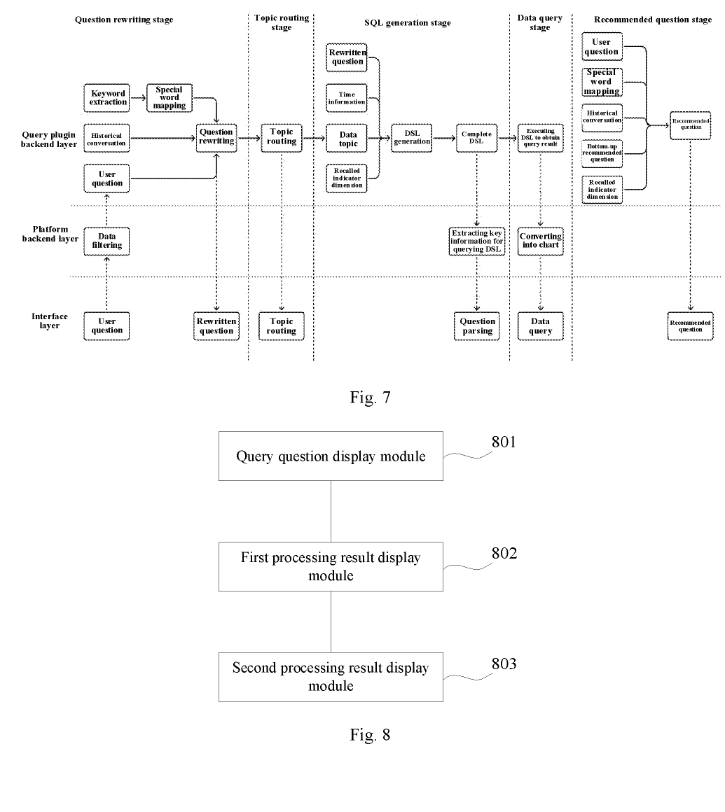

As a specific application embodiment of the embodiments of the present application, as shown in FIG. 7, three levels are involved in the data query process, namely, an interface layer, a platform backend layer, and a query plugin backend layer. Specifically, the interface layer corresponds to a terminal device, the platform backend layer corresponds to a server for deploying an application in the terminal device, and the query plugin backend layer corresponds to a platform server. A user inputs a user question by interacting with an interactive interface, and the platform backend layer screens the user question to determine whether it belongs to a data query question, and if it is determined to belong to the data query question, a query instruction is sent to the query plugin backend layer. The processing process experienced by the query plugin backend layer includes a question rewriting stage, a topic routing stage, an SQL generation stage, a data query stage, and a question recommending stage. In the question rewriting stage, after keyword extraction is performed on the user question, if there is a special word, mapping of the special word is performed, and then question rewriting is performed in combination with the user question and a historical conversation, and the rewritten question is fed back to the interface layer for display. Then the topic routing stage is entered, in which the topic routing is matched based on the rewritten question to obtain and feed back the topic routing. Then a DSL is generated in combination with the rewritten question, time information, a data topic, and a recalled indicator dimension to obtain a complete SDL. The platform backend layer extracts key information for querying the DSL from the complete SDL to obtain a parsed field and a field value of question parsing, and displays the parsed field and the field value thereof on the interface layer. Then the data query stage is entered, in which a query result is obtained by executing the DSL, and the query result is fed back to the platform backend layer, and the platform backend layer converts the query result into a chart and displays the data query result on the interface layer. Finally, the question recommending stage is entered, in which a recommended question is generated through the user question, the special word mapping, the historical conversation, a bottom-up recommended question, and the recalled indicator dimension, and the recommendation is fed back to the interface layer for display.

In this embodiment, a data query apparatus is further provided, and the apparatus is configured to implement the above embodiments and preferred implementations, which will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

This embodiment provides a data query apparatus, as shown in FIG. 8, including:
a query question display module 801, configured to display a first query question on an interactive page in response to a query instruction for the first query question, and trigger processing of the first query question according to a query plan, where the query plan includes a plurality of query steps;
a first processing result display module 802, configured to display a first processing result of each of the query steps on the interactive page; and
a second processing result display module 803, configured to trigger re-query for the first query question in response to a modification instruction for the first processing result of a target query step to obtain and display a second processing result of each of the query steps.

In some optional implementations, the target query step includes at least one of question parsing or data query; a first processing result of the question parsing includes a parsed field and a field value of the parsed field; and a first processing result of the data query includes displaying query data in a first style.

In some optional implementations, the display module is configured to display the parsed field and the field value of the parsed field of the question parsing on the interactive page, and display the query data in the first style.

In some optional implementations, the second processing result display module 803 includes:
a modification unit, configured to determine a modification result in response to the modification instruction for the field value of the parsed field and/or the first style; and
a re-query unit, configured to trigger re-query for the first query question based on the modification result in response to an interactive instruction on a re-query control on the interactive page to obtain and display the second processing result of each of the query steps.

In some optional implementations, the query steps further include question rewriting, topic routing, and question recommending; and processing results of the question rewriting, the topic routing, the question parsing, the data query, and the question recommending are displayed in sequence on the interactive page.

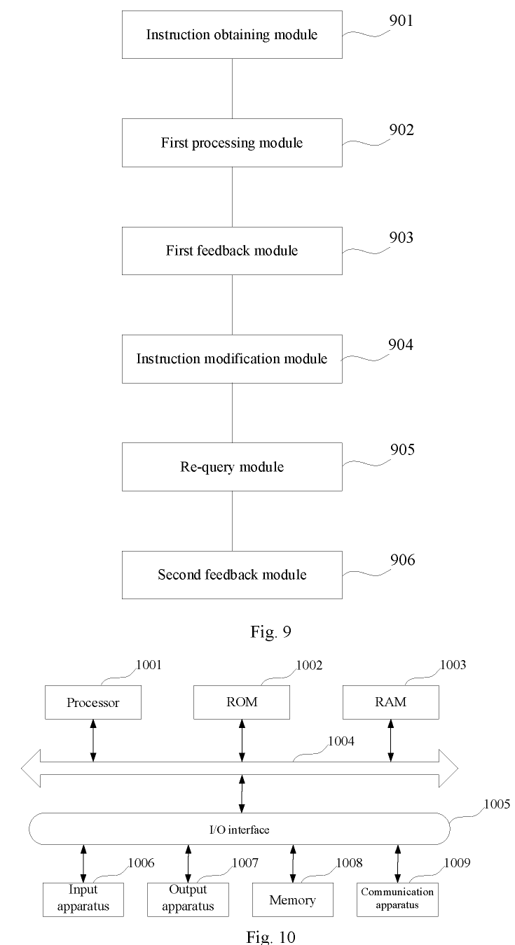

This embodiment provides a data query apparatus, as shown in FIG. 9, including:
an instruction obtaining module 901, configured to obtain a query instruction for a first query question from a query object;
a first processing module 902, configured to process the first query question according to a query plan to obtain a first processing result of each query step in the query plan, where the query plan includes a plurality of query steps;
a first feedback module 903, configured to feed back the first processing result of the query step to a requester of the query instruction in sequence based on an order of the query steps, where an interactive page of the requester is configured to display a processing result of the query step;
an instruction modification module 904, configured to obtain a modification instruction for the first processing result of a target query step;
a re-query module 905, configured to re-query the first query question based on a modification result and the query plan to obtain a second processing result of each of the query steps; and
a second feedback module 906, configured to feed back the second processing result of the query step to the requester of the query instruction in sequence based on the order of the query steps.

In some optional implementations, the query steps include question rewriting, and the first processing module 902 includes:
a historical conversation obtaining unit, configured to obtain a historical conversation between the query object and an agent;
a replacement word determination unit, configured to determine a replacement word of a target word if the target word exists in the first query question;
a first prompt information generation unit, configured to generate first prompt information based on the first query question, the historical conversation, and the replacement word of the target word; and
a rewritten question output unit, configured to output a rewritten question of the first query question based on the first prompt information using a question rewriting model, the first processing result of the question rewriting including the rewritten question.

In some optional implementations, the first processing module 902 includes:
a mapping obtaining unit, configured to obtain a word mapping corresponding to the query object, the word mapping being used to represent a mapping relationship between the target word and the replacement word; and
a target word determination unit, configured to determine that the target word exists in the first query question if a word in the first query question may be queried in the word mapping.

In some optional implementations, the query steps include topic routing, and the first processing module 902 includes:
an information obtaining unit, configured to obtain information about a query topic corresponding to the query object, the information about the query topic including at least one of a field under the query topic or enumeration meta-information;
a word segmentation unit, configured to perform word segmentation on the rewritten question of the first query question based on the information about the query topic to obtain a recall result of a keyword under each of the query topics;
a filtering unit, configured to filter the recall result for each of the query topics to obtain a recall field with a smallest distance of the keyword in the recall result;
a screening unit, configured to screen the query topics based on the smallest distance corresponding to the recall result of the keyword under each of the query topics to determine a target query topic of the first query question.

In some optional implementations, the filtering unit includes:
a removing subunit, configured to, for the keyword under each of the query topics, if a preset identification exists in the recall result corresponding to the keyword, remove the preset identification and content corresponding to the preset identification to obtain a processed recall result;
a correcting subunit, configured to correct a distance corresponding to the processed recall result based on a matching degree between the keyword and the processed recall result to obtain a corrected distance; and
a field determining subunit, configured to screen out the recall field with the smallest distance in the recall result for the keyword under the query topic based on the corrected distance.

In some optional implementations, the correcting subunit includes:
a first setting subunit, configured to, if the keyword completely matches the processed recall result, set the distance corresponding to the processed recall result to a preset minimum distance to obtain the corrected distance;
a suffix word obtaining subunit, configured to, if the keyword does not match the processed recall result, obtain a suffix word corresponding to the query object;
a concatenating subunit, configured to concatenate the keyword and the suffix word to obtain a concatenated result; and
a second setting subunit, configured to, if the concatenated result completely matches the processed recall result, set the distance corresponding to the processed recall result to the preset minimum distance to obtain the corrected distance.

In some optional implementations, the screening unit includes:
a counting subunit, configured to count, for each of the query topics, a first number of recall fields with a distance less than a first preset distance, a second number of recall fields with a distance less than a second preset distance, and a sum of the distances in the recall fields corresponding to all keywords, the first preset distance being less than the second preset distance; and
a sorting unit, configured to sort based on a priority of the first number, the second number, the sum of the distances, and a weight of the query topic to determine the target query topic of the first query question.

In some optional implementations, the query steps include question parsing, and the first processing module 902 includes:
a time information obtaining unit, configured to obtain current time information;
a second prompt unit, configured to generate second prompt information based on the current time information, the rewritten question of the first query question, a query topic of the first query question, and an optional parsed field;
a generation unit, configured to generate a domain specific language based on the second prompt information using a large language model; and
an information obtaining unit, configured to obtain a parsed field of the first query question and a field value of the parsed field in the domain specific language.

The data query apparatus provided in this embodiment of the present disclosure may perform the data query method provided in any embodiment of the present disclosure, and has corresponding functional modules and beneficial effects for performing the method. In the apparatus, in a process of processing the first query question, the processing is performed according to the query plan, and the corresponding first processing result is displayed for each query step in the query plan. The first processing result of each query step is displayed, so that a user may intuitively understand a processing condition of each query step, and an inaccurate processing result may be modified in an interactive manner to trigger re-query. In the method, a query result of each query step may be intuitively displayed, which facilitates intuitive understanding of an inaccurate query step, so that the inaccurate query step may be modified in time and then re-query is performed, thereby improving query efficiency. Further functional descriptions of the above modules and units are the same as those in the corresponding embodiments above, and will not be repeated here.

FIG. 10 is a schematic structural diagram of an electronic device provided by an embodiment of the present disclosure.

Reference is made specifically to FIG. 10 below, which illustrates a schematic structural diagram of an electronic device suitable for implementing the embodiments of the present disclosure. The electronic device may include a processor (for example, a central processing unit, a graphics processor, etc.) 1001, which may perform various appropriate actions and processing according to a program stored in a read-only memory (ROM) 1002 or a program loaded from a memory 1008 into a random access memory (RAM) 1003. The RAM 1003 further stores various programs and data required for operations of the electronic device. The processor 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; a memory 1008 including, for example, a magnetic tape and a hard disk; and a communication apparatus 1009. The communication apparatus 1009 may allow the electronic device to perform wireless or wired communication with other devices to exchange data. Although FIG. 10 shows the electronic device having various apparatuses, it should be understood that it is not required to implement or have all the apparatuses shown, and alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, the computer program including program code for performing the method shown in the flowchart. In such an embodiment, the computer program may be downloaded and installed from a network through the communication apparatus 1009, or installed from the memory 1008, or installed from the ROM 1002. When the computer program is executed by the processor 1001, the above-mentioned functions defined in the data query method of the embodiment of the present disclosure are executed.

The electronic device shown in FIG. 10 is only an example, and should not impose any limitation on the function and scope of use of the embodiments of the present disclosure.

An embodiment of the present application further provides a computer-readable storage medium. The method according to the embodiment of the present application may be implemented in hardware and firmware, or implemented as computer code that may be recorded in a storage medium or originally stored in a remote storage medium or a non-transitory machine-readable storage medium and downloaded through a network and will be stored in a local storage medium, so that the method described herein may be processed by such software stored on the storage medium using a general-purpose computer, a dedicated processor, or programmable or dedicated hardware. The storage medium may be a magnetic disk, an optical disk, a read-only memory, a random access memory, a flash memory, a hard disk or a solid-state disk, etc. Further, the storage medium may further include a combination of the above kinds of memories. It may be understood that the computer, the processor, the microprocessor controller or the programmable hardware includes a storage component that may store or receive software or computer code, and when the software or computer code is accessed and executed by the computer, the processor or the hardware, the data query method shown in the above embodiments is implemented.

A part of the present application may be applied as a computer program product, such as computer program instructions, which, when executed by a computer, may invoke or provide the method and/or technical solutions according to the present application through operations of the computer. Those skilled in the art should understand that the computer program instructions may be stored in a computer-readable medium in a form including but not limited to a source file, an executable file, an installation package file, etc., and accordingly, the computer program instructions may be executed by the computer in a manner including but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present application are described in conjunction with the drawings, those skilled in the art may make various modifications and variations without departing from the spirit and scope of the present application, and such modifications and variations fall within the scope defined by the appended claims.

What is claimed is:

1. A data query method, comprising:
displaying a first query question on an interactive page in response to a query instruction for the first query question, and triggering processing of the first query question according to a query plan, wherein the query plan comprises a plurality of query steps;
displaying a first processing result of each of the query steps on the interactive page; and
triggering re-query for the first query question in response to a modification instruction for the first processing result of a first query step, to obtain and display a second processing result of each of the query steps.

2. The method of claim 1, wherein the first query step comprises at least one of question parsing or data query;
a first processing result of the question parsing comprises a parsed field and a field value of the parsed field; and
a first processing result of the data query comprises displaying query data in a first style.

3. The method of claim 2, wherein the parsed field of the question parsing and the field value of the parsed field are displayed on the interactive page, and the query data is displayed in the first style.

4. The method of claim 2, wherein the triggering re-query for the first query question in response to a modification instruction for the first processing result of a first query step, to obtain and display a second processing result of each of the query steps comprises:
determining a modification result in response to the modification instruction for at least one of the field value of the parsed field or the first style; and
triggering re-query for the first query question based on the modification result in response to an interactive instruction on a re-query control on the interactive page, to obtain and display the second processing result of each of the query steps.

5. The method of claim 1, wherein the query steps further comprise question rewriting, topic routing, and question recommending; and
processing results of the question rewriting, the topic routing, the question parsing, the data query, and the question recommending are displayed in sequence on the interactive page.

6. A data query method, comprising:
obtaining a query instruction for a first query question from a query object;
processing the first query question according to a query plan to obtain a first processing result of each query step in the query plan, wherein the query plan comprises a plurality of query steps;
feeding back the first processing result of the query step to a requester of the query instruction in sequence based on an order of the query steps, wherein an interactive page of the requester is configured to display a processing result of the query step;
obtaining a modification instruction for the first processing result of a first query step;
re-querying the first query question based on a modification result and the query plan to obtain a second processing result of each of the query steps; and
feeding back the second processing result of the query step to the requester of the query instruction in sequence based on the order of the query steps.

7. The method of claim 6, wherein the query steps comprise question rewriting, and the processing the first query question according to a query plan to obtain a first processing result of each query step in the query plan comprises:
obtaining a historical conversation between the query object and an agent;
determining a replacement word of a first word if the first word exists in the first query question;
generating first prompt information based on the first query question, the historical conversation, and the replacement word of the first word; and
outputting a rewritten question of the first query question based on the first prompt information using a question rewriting model, wherein a first processing result of the question rewriting comprises the rewritten question.

8. The method of claim 7, comprising:
obtaining a word mapping corresponding to the query object, wherein the word mapping is configured to represent a mapping relationship between the first word and the replacement word; and
determining that the first word exists in the first query question in response to that a word in the first query question is queried in the word mapping.

9. The method of claim 6, wherein the query steps comprise topic routing, and the processing the first query question according to a query plan to obtain a first processing result of each query step in the query plan comprises:
obtaining information about a query topic corresponding to the query object, wherein the information about the query topic comprises at least one of a field under the query topic or enumeration meta-information;
performing word segmentation on a rewritten question of the first query question based on the information about the query topic, to obtain a recall result of a keyword under each of the query topics;
filtering the recall result for each of the query topics to obtain a recall field with a smallest distance of the keyword in the recall result; and
screening the query topics based on the smallest distance corresponding to the recall result of the keyword under each of the query topics to determine a first query topic of the first query question.

10. The method of claim 9, wherein the filtering the recall result for each of the query topics to obtain a recall field with a smallest distance of the keyword in the recall result comprises:
for the keyword under each of the query topics, if a preset identification exists in the recall result corresponding to the keyword, removing the preset identification and content corresponding to the preset identification to obtain a processed recall result;
correcting a distance corresponding to the processed recall result based on a matching degree between the keyword and the processed recall result to obtain a corrected distance; and
screening out the recall field with the smallest distance in the recall result for the keyword under the query topic based on the corrected distance.

11. The method of claim 10, wherein the correcting a distance corresponding to the processed recall result based on a matching degree between the keyword and the processed recall result to obtain a corrected distance comprises:
in response to that the keyword completely matches the processed recall result, setting the distance corresponding to the processed recall result to a preset minimum distance to obtain the corrected distance;
in response to that the keyword does not match the processed recall result, obtaining a suffix word corresponding to the query object;
concatenating the keyword and the suffix word to obtain a concatenated result; and
in response to that the concatenated result completely matches the processed recall result, setting the distance corresponding to the processed recall result to the preset minimum distance to obtain the corrected distance.

12. The method of claim 9, wherein the screening the query topics based on the smallest distance corresponding to the recall result of the keyword under each of the query topics to determine a first query topic of the first query question comprises:
counting, for each of the query topics, a first number of recall fields with a distance less than a first preset distance, a second number of recall fields with a distance less than a second preset distance, and a sum of the distances in the recall fields corresponding to all keywords, wherein the first preset distance is less than the second preset distance; and
sorting based on a priority of the first number, the second number, the sum of the distances, and a weight of the query topic to determine the first query topic of the first query question.

13. The method of claim 6, wherein the query steps comprise question parsing, and the processing the first query question according to a query plan to obtain a first processing result of each query step in the query plan comprises:
obtaining current time information;
generating second prompt information based on the current time information, a rewritten question of the first query question, a query topic of the first query question, and an optional parsed field;
generating a domain specific language based on the second prompt information using a large language model; and
obtaining a parsed field of the first query question and a field value of the parsed field in the domain specific language.

14. An electronic device, comprising:
at least one memory and at least one processor, wherein the at least one memory and the at least one processor are communicatively connected to each other, the at least one memory stores computer instructions, and the at least one processor executes the computer instructions to perform a data query method, comprising:
displaying a first query question on an interactive page in response to a query instruction for the first query question, and triggering processing of the first query question according to a query plan, wherein the query plan comprises a plurality of query steps;
displaying a first processing result of each of the query steps on the interactive page; and
triggering re-query for the first query question in response to a modification instruction for the first processing result of a first query step, to obtain and display a second processing result of each of the query steps.

15. The electronic device of claim 14, wherein the first query step comprises at least one of question parsing or data query;
a first processing result of the question parsing comprises a parsed field and a field value of the parsed field; and
a first processing result of the data query comprises displaying query data in a first style.

16. The electronic device of claim 15, wherein the parsed field of the question parsing and the field value of the parsed field are displayed on the interactive page, and the query data is displayed in the first style.

17. The electronic device of claim 15, wherein the triggering re-query for the first query question in response to a modification instruction for the first processing result of a first query step, to obtain and display a second processing result of each of the query steps comprises:
determining a modification result in response to the modification instruction for at least one of the field value of the parsed field or the first style; and
triggering re-query for the first query question based on the modification result in response to an interactive instruction on a re-query control on the interactive page, to obtain and display the second processing result of each of the query steps.

18. An electronic device, comprising:
at least one memory and at least one processor, wherein the at least one memory and the at least one processor are communicatively connected to each other, the at least one memory stores computer instructions, and the at least one processor executes the computer instructions to perform the data query method of claim 6.

19. A non-transitory computer-readable storage medium, wherein the computer-readable storage medium stores computer instructions, and the computer instructions are configured to enable a computer to perform the data query method of claim 1.

20. A non-transitory computer-readable storage medium, wherein the computer-readable storage medium stores computer instructions, and the computer instructions are configured to enable a computer to perform the data query method of claim 6.
